(19) United States
(12) Patent Application Publication
(10) Pub. No.: US 2006/0198316 A1
(43) Pub. Date: Sep. 7, 2006

(54) System for remote configuration of QoS parameters

(75) Inventors: Amol Bhagwat, Boulder, CO (US); Kevin G. Luehrs, Louisville, CO (US); John G. Bevilacqua, Boulder, CO (US)

Correspondence Address: PATTON BOGGS, 1660 LINCOLN ST, SUITE 2050, DENVER, CO, 80264, US

(73) Assignee: Cable Television Laboratories, Inc., Louisville, CO (US)

(21) Appl. No.: 11/070,352

(22) Filed: Mar. 2, 2005

(51) Int. Cl. H04L 1/00

(52) U.S. Cl. 370/252

(57) ABSTRACT

The system for remote configuration of QoS parameters enables a service provider to remotely configure the Quality of Service parameters for each application or service offered by networked devices connected to a LAN. This is accomplished by a service provider creating and maintaining a reference repository of the Quality of Service information for each of the subscriber devices that are connected to the Local Area Network. When an application or service initiates its operation, it passes information about itself to a service provider managed server which provides the subscriber device with necessary configuration information, which may include a network address and other configuration parameters. The service provider's server identifies Quality of Service parameters for various applications or services on the subscriber device and communicates association of service identifiers with Quality of Service parameters to the subscriber device. The subscriber device populates a data structure with the service identifiers and Quality of Service parameters association information.

### FIELD OF THE INVENTION

This invention relates to the remote management by a service provider of the subscriber devices connected to a Local Area Network and the Quality of Service (QoS) parameters which regulate the operation of the subscriber devices.

### PROBLEM

It is a problem in the field of Local Area Networks for a service provider to deliver multiple high-speed real-time audio and video data streams without disruption in addition to other data to a multiplicity of subscribers and/or subscriber devices over a shared transmission medium. In particular, a segment of this problem is to guarantee that the real-time data is delivered to a subscriber device when it is required with predetermined latency and without interruption. The accurate and timely delivery of data encompasses various factors, which are typically determined as a function of the data content. For example, IP telephony data requires delay and jitter guarantees, Entertainment Video on Demand and Networked PVR both require bandwidth guarantees, etc. Without these guarantees, a service provider is not able to offer such services to their subscribers, due to the lack of quality and reliability that would be delivered to the subscribers.

With the presence of multiple subscriber devices on a Local Area Network, whether located behind a gateway or directly connected to the Local Area Network, the service provider who delivers multiple high-speed real-time audio and video data streams has no ability to control or manage the Quality of Service parameters that are used by each of the subscriber devices to manage their performance properties. With various applications competing for LAN resources, there are no guarantees for their acceptable level of performance.

### SOLUTION

The above-described problems are solved and a technical advance achieved by the present system for remote configuration of QoS parameters which enables a service provider to remotely configure the Quality of Service parameters for each application or service offered by networked devices connected to the LAN.

This is accomplished by a service provider creating and maintaining a reference repository of the Quality of Service information for each of the subscriber devices that are connected to the Local Area Network. When an application or service initiates its operation, such as booting up, it passes information about itself to a service provider managed server which is capable of providing the subscriber device with necessary configuration information, which may include a network address and other configuration parameters. Using the Quality of Service information stored in the reference repository and the list of service identifiers passed by a subscriber device, the service provider's server identifies Quality of Service parameters for various application or service on the subscriber device and communicates association of service identifiers with Quality of Service parameters (among other configuration parameters) to the subscriber device. The subscriber device populates a data structure with the service identifiers and Quality of Service parameters association information. Once this association is established, a service provider or a subscriber can customize Quality of Service parameters for traffic streams between a subscriber device to a specific application on some other specific subscriber device over the LAN by creating additional entries of Quality of Service parameters for specific service identifier with specific destination IP and destination port field in the data structure.

### BRIEF DESCRIPTION OF THE DRAWING

FIG. 1 illustrates, in block diagram form, the present system for remote configuration of QoS parameters and a typical environment in which it operates;

FIG. 2 illustrates, in tabular form, the data structures used by the present system for remote configuration of QoS parameters; and

FIG. 3 illustrates, in flow diagram form, the typical operation of the present system for remote configuration of QoS parameters.

### DETAILED DESCRIPTION

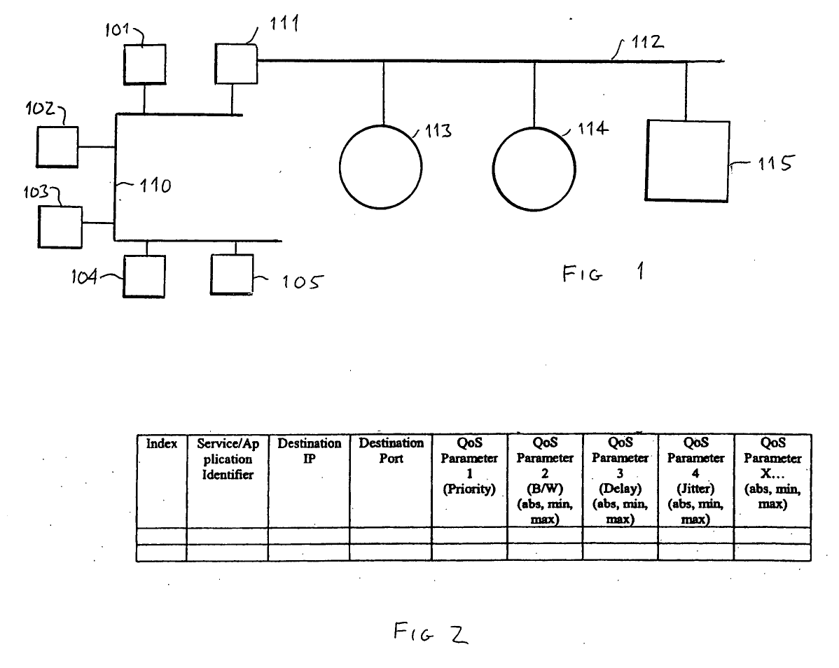

FIG. 1 illustrates, in block diagram form, the present system for remote configuration of QoS parameters and a typical environment in which it operates. The use of Local Area Networks enables a service provider to deliver program content to a multiplicity of subscribers over a shared transmission medium. Examples of Local Area Networks include broadband service providers (Cable, DSL, Satellite, Fixed Wireless) who deliver multiple high-speed real-time audio and video data streams without disruption in addition to other data. The Local Area Network 100 illustrated in FIG. 1 consists of a plurality of devices 101-105, termed “subscriber devices” herein, each of which is equipped with apparatus and/or software to regulate various Quality of Service parameters that are assigned to that subscriber device. The subscriber devices 101-105 are connected to a transmission medium 110 for the exchange of data among the subscriber devices 101-105. The subscriber devices can include terminals, servers, and other such elements. The Local Area Network 100 can also include a gateway server 111, which serves to interconnect the transmission medium 110 and its plurality of subscriber devices 101-105 to another transmission medium 112. The other transmission medium 112 can serve additional Local Area Network loops 113, 114 and includes a service provider's server 115 that functions to manage the operation of the Local Area Network 100 and provide data for transmission to the subscriber devices 101-105 served by the Local Area Network 100.

The present system for remote configuration of QoS parameters 120 can be implemented in whole or in part in the gateway server 111 or the service provider's server 115, which includes the service provider's reference repository as described below.

Quality of Service

Quality of Service refers to the performance properties of a network service, and typically includes factors such as throughput, transit delay, and priority. Some protocols allow packets or streams to include Quality of Service requirements. Quality of Service is a generic term that is used to take into account a number of techniques and strategies that can assure applications and subscribers a predictable service from a network and the other components involved, such as operating systems. This is accomplished by deploying various mechanisms; including scheduling, control admission, shaping, control on routing latency/performance, and resource planning to provide the reliable service.

Deterministic Quality of Service is a factor that enables equipment manufacturers to prioritize telephone voice data higher than computer data, for example, in a home networking environment. The technology achieves this prioritization by permitting subscribers to assign specific time slots for each stream of data to thereby guarantee that the real-time data is delivered when it is required with predetermined latency and without interruption. This capability enables service providers to offer a multitude of subscriber services to a subscriber, such as: POTS, high speed Internet access, broadcast and on-demand video, all delivered over the home network to thereby lower subscriber churn and increase revenue per subscriber. This capability also allows the system to transport data with inherent Quality of Service requirements.

Local Area Network Applications

An example of a Local Area Network application is that, using existing home telephone wiring, consumers with multiple Personal Computers can take advantage of a single, high-speed Internet connection to simultaneously check e-mail, browse the Web, and share peripherals as well as to stream audio and video content between consumer electronics devices and Personal Computers without interfering with standard telephone services. The deterministic Quality of Service (QoS) provided by the system for remote configuration of QoS parameters complements wireless networking technologies by providing the ideal high speed backbone for a home multimedia network that requires a fast and reliable channel to distribute multiple, feature-rich digital audio and video applications throughout a home. This is accomplished in part by providing interface functionality in any of a variety of devices, including pre-configured Personal Computers, network interface cards and adapters, residential gateways, broadband modems, printers, multimedia devices, Internet appliances, set top boxes, and consumer electronics products such as TVs, DVDs, DVRs, and home entertainment systems. These interfaces comprise adapters and bridges and function as an interface to interconnect the subscriber device to the multimedia home network.

In a shared LAN environment, various applications are competing for LAN resources and subscribers require guarantees for their acceptable level of performance. Examples are IP telephony (requires delay and jitter guarantees), Entertainment Video on Demand and Networked PVR (requires bandwidth guarantees), etc. Without these guarantees, a service provider is not able to offer such services to their subscribers. By employing the capabilities of the interface functionality noted above, in conjunction with the capabilities of the system for remote configuration of Quality of Service parameters, a service provider can remotely manage and customize (according to subscriber and service provider preference) these Quality of Service parameters and offer shared LAN environment that provides Quality of Service capabilities. A service provider can potentially charge a monthly subscription fee for such value added services, either for an individual service or for a bundle of services.

System for Remote Configuration of QoS Parameters

Several LAN networking specifications and standards provide varying degrees of support for Quality of Service. Today, a majority of these technologies cannot provide perfect guarantees of bandwidth, jitter, and delay parameters. However, almost all of these LAN technologies have support for prioritized access to the shared media that enables prioritization of traffic using priorities. However, a very few known applications actually make use of the priorities in these LAN Interface technologies, and those that do ‘hard code’ the priority value or otherwise do not permit the subscriber or other parties to modify the priority value.

In a LAN environment, such as a high-speed data service subscriber's home or business LAN, many applications may be sharing network bandwidth to transfer data between the applications themselves and applications running on other Subscriber device 101s. As mentioned above, applications typically either do not make use of prioritized media access capability provided by the LAN technology, or they take advantage of it but do not permit the priority setting to be changed. In multiple application environments, it is likely that a subscriber would want to change the existing priorities of applications or services according to their preferences. These preferences could also potentially change from person to person in the same home.

A data communication service provider can support the subscriber's need or desire to assign different Quality of Service parameters to different services that use the LAN for the transfer of digital information in the LAN. By using the method proposed herein, a service provider can change the priorities of certain applications, as newer, higher priority applications are developed. Thus, the system for remote configuration of Quality of Service parameters provides a greater flexibility to a subscriber and a service provider in configuration of the selected Quality of Service parameters (priority, bandwidth, jitter, delay, etc.) necessary for various applications or services deployed over the LAN. There is no present mechanism that provides this capability since existing applications may support the use of a LAN Interface technology's Quality of Service capabilities, but they do not have a source of information and a mechanism for notifying and remotely configuring the Quality of Service parameters that they should use.

Data Structures for Management of QoS Parameters

FIG. 2 illustrates, in tabular form, the data structures used by the present system for remote configuration of Quality of Service parameters. A service provider creates and maintains a reference repository of the information represented by the Table illustrated in FIG. 2, which shows a typical set of information. The service provider's reference repository may have one or more entries for the same service/application identifier.

A service/application identifier uniquely identifies a service or an application running on a subscriber device that is served by the Local Area Network 100. Various Quality of Service parameters like priority, bandwidth, jitter, delay, etc., are assigned against this identifier. A default value for the priority may also be assigned to each service identifier. The values for these parameters can be in the form of an absolute value or it can be in the form of a minimum-maximum range of values.

Destination IP and Destination Port fields can be used to assign specific Quality of Service parameters for traffic streams that are transmitted between a subscriber device and a specific application on some other specific subscriber device over the LAN according to the needs and desires of a subscriber or a service provider.

The service provider may establish a copy of the complete reference table, or a subset of the reference table, in a LAN gateway device 111 that is in closer proximity to the subscriber device. Such a LAN gateway 111 enables sharing of the Internet connection among the various subscriber devices and is capable of being configured by the service provider. An example of the possible LAN gateway device 111 is a residential gateway or home router device.

Remote Configuration of QoS Parameters

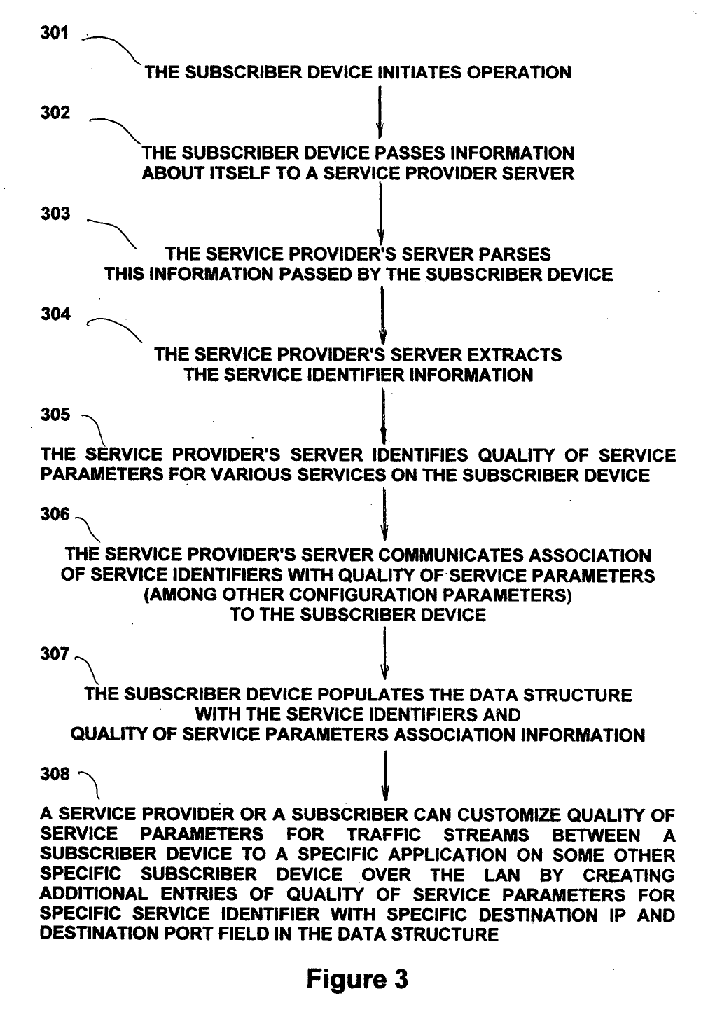

FIG. 3 illustrates, in flow diagram form, the typical operation of the present system for remote configuration of Quality of Service parameters. This process is used to illustrate the functionality of the system for remote configuration of Quality of Service parameters and is not intended to limit the applicability of these concepts to a specific embodiment as shown herein.

When the subscriber device 101 initiates operation, such as booting up at step 301, it passes information about itself at step 302 to a service provider managed server 115, which is capable of providing the subscriber devices 101-105 with necessary configuration information, which may include a network address and other configuration parameters. Such a server 115 may reside in the service provider's network operations center or it may be a LAN gateway device 111 in closer proximity to the LAN. Within the information that is sent by the subscriber device 101 to the server 115, there is a list of service or application identifiers that the subscriber device offers. The service provider's server 115 at step 303 parses this information passed by the subscriber device 101 and extracts the service identifier information at step 304. Using the information from the Table shown in FIG. 2 stored in the reference repository and the list of service identifiers passed by a subscriber device 101, the service provider's server at step 305 identifies Quality of Service parameters for various services on the subscriber device 101 and communicates association of service identifiers with Quality of Service parameters (among other configuration parameters) to the subscriber device 101 at step 306. The subscriber device 101 populates at step 307 the data structure, such as the Table shown in FIG. 2, with the service identifiers and Quality of Service parameters association information. Once this association is established, a service provider or a subscriber can customize Quality of Service parameters for traffic streams between a subscriber device 101 to a specific application on some other specific subscriber device 105 over the LAN by creating additional entries of Quality of Service parameters for specific service identifier with specific destination IP and destination port field in the data structure (Table of FIG. 2) at step 308. This customization can be done either at the server in the service provider's network operations center or in the LAN gateway device. The application services running on the subscriber device 101 make use of these Quality of Service parameters conveyed by the service provider and stored in the subscriber device 101 while transmitting data over the shared LAN media.

### SUMMARY

The system for remote configuration of Quality of Service parameters enables a service provider to remotely configure the Quality of Service parameters for each application or service offered by networked devices connected to a Local Area Network. This is accomplished by a service provider creating and maintaining a reference repository of the Quality of Service information for each of the subscriber devices that are connected to the Local Area Network and communicating an association of service identifiers with Quality of Service parameters to the subscriber devices.

What is claimed:

1. A system for managing Quality of Service for a plurality of applications and services that execute on a plurality of devices that are connected to a shared transmission medium, wherein said plurality of devices include apparatus for controlling performance properties of the associated device comprising:
reference repository means for maintaining Quality of Service data for at least one of said plurality of applications and services, said Quality of Service data including at least one Quality of Service parameter that defines performance properties of a one of a network application and service; and
Quality of Service control means for transmitting data from said reference repository means to a one of said plurality of applications and services indicative of at least one of said Quality of Service parameters associated with said one of said applications and services.

2. The system for managing Quality of Service for devices of claim 1 wherein said reference repository means comprises:
port definition means for assigning Destination IP and Destination Port fields to assign specific Quality of Service parameters for traffic streams over said shared transmission medium between a first of said plurality of devices and a specific one of an application and service executing on a second of said plurality of devices.

3. The system for managing Quality of Service for devices of claim 1 wherein said reference repository means comprises:
customization means for enabling modification of said Quality of Service parameters to support traffic streams between a device to a specific one of an application and a service on some other specific device over the shared transmission medium by creating additional entries of Quality of Service parameters for specific service identifier with specific destination IP and destination port field in said Quality of Service data.

4. The system for managing Quality of Service for devices of claim 1 wherein said Quality of Service control means comprises:
data entry means, responsive to initiation of operation of a one of said plurality of applications and services, for receiving information from said one of said plurality of applications and services that describes said one of said plurality of applications and services; and
configuration means for providing said one of said plurality of applications and services with configuration information.

5. The system for managing Quality of Service for devices of claim 4 wherein said configuration means comprises:
network address means for assigning a network address to a device on which said one of said plurality of applications and services executes.

6. The system for managing Quality of Service for devices of claim 1 wherein said reference repository means comprises:
application identification means, responsive to receipt of a list of services and applications identifiers that the device offers, for parsing this information to extract the service identifier information; and
means for identifying Quality of Service parameters for various applications and services on the device.

7. A method for managing Quality of Service for a plurality of applications and services that execute on a plurality of devices that are connected to a shared transmission medium, wherein said plurality of devices include apparatus for controlling performance properties of the associated device comprising:
maintaining Quality of Service data in a reference repository for at least one of said plurality of applications and services, said Quality of Service data including at least one Quality of Service parameter that defines performance properties of a one of a network application and service; and
transmitting data from said reference repository to a one of said plurality of applications and services indicative of at least one of said Quality of Service parameters associated with said one of said applications and services.

8. The method for managing Quality of Service for devices of claim 7 wherein said step of maintaining comprises:
assigning Destination IP and Destination Port fields to assign specific Quality of Service parameters for traffic streams over said shared transmission medium between a first of said plurality of devices and a specific one of an application and service executing on a second of said plurality of devices.

9. The method for managing Quality of Service for devices of claim 7 wherein said step of maintaining comprises:
enabling modification of said Quality of Service parameters to support traffic streams between a device to a specific one of an application and a service on some other specific device over the shared transmission medium by creating additional entries of Quality of Service parameters for specific service identifier with specific destination IP and destination port field in said Quality of Service data.

10. The method for managing Quality of Service for devices of claim 7 wherein said step of transmitting comprises:
receiving, in response to initiation of operation of a one of said plurality of applications and services, information from said one of said plurality of applications and services that describes said one of said plurality of applications and services; and
providing said one of said plurality of applications and services with configuration information.

11. The method for managing Quality of Service for devices of claim 10 wherein said step of providing comprises:
assigning a network address to a device on which said one of said plurality of applications and services executes.

12. The method for managing Quality of Service for devices of claim 7 wherein said step of maintaining comprises:
parsing, in response to receipt of a list of services and applications identifiers that the device offers, this information to extract the service identifier information; and
identifying Quality of Service parameters for various services on the device.
